(19) United States
(12) Patent Application Publication
(10) Pub. No.: US 2015/0178357 A1
(43) Pub. Date: Jun. 25, 2015

(54) Method and system for displaying MES records in a grid on an MES client screen

(71) Applicant: SIEMENS AKTIENGESELLSCHAFT, MUENCHEN (DE)

(72) Inventors: SIMONE BELOTTI, GENOVA (IT); STAFANO NOFERI, GENOA (IT)

(21) Appl. No.: 14/577,231

(22) Filed: Dec. 19, 2014

(30) Foreign Application Priority Data
Dec. 19, 2013 (EP) 13198377.7

(51) Int. Cl. G06F 17/30

(52) U.S. Cl. CPC G06F 17/30554

(57) ABSTRACT

MES records are displayed in a grid in a MES client screen. The MES records to be displayed are a set of records resulting from a query to a database by the MES client, and the record set is displayed via a number of grid pages. Each grid page displays a corresponding record subset and each grid page can be selected for display on the screen by selecting given grid pager navigation commands. First, the MES client queries the database to retrieve a first subset of MES records. The first retrieved MES record subset is displayed while the database is queried to count the exact total count of records of the record set to obtain a total exact record count value. Then the resulting total value is displayed on the screen, and grid pager navigation commands are displayed, enabling user selection for another grid page of another corresponding record subset.

### CROSS-REFERENCE TO RELATED APPLICATION

This application claims the priority, under 35 U.S.C. §119, of European patent application EP 13198377.7, filed Dec. 19, 2013; the prior application is herewith incorporated by reference in its entirety.

### BACKGROUND OF THE INVENTION

1. Field of the Invention

The present invention lies in the field of manufacturing execution systems (MES) and relates, more particularly, to a method and to a system for displaying MES records on a grid in a MES client screen. The MES records to be displayed are a set of records resulting from a query to a database by the MES client, and the record set is to be displayed via a number of grid pages, each grid page displaying a corresponding record subset; each grid page can be displayed on the MES screen by selecting given grid pager navigation commands.

In the world of industrial automation of today, in order to increase competitiveness, manufacturing companies need to simultaneously reduce time-to-market, increase process visibility and production flexibility, optimize forecasting and scheduling, and reduce scrap, stock levels and downtimes; all while ensuring optimal quality and production efficiency across all global facilities.

Hence in order to meet these demanding goals, manufacturing companies require an integrated IT infrastructure that helps them in coordinating production on a global scale and, if necessary, in real time. The manufacturing execution system (MES) is generally known as the IT layer that integrates the business systems (e.g. ERP) and production control systems.

Siemens Corp., the assignee of this invention, offers a broad range of MES products, under its SIMATIC® product family.

As defined by the Manufacturing Enterprise Solutions Association (MESA International), the MES system “is a dynamic information system that drives effective execution of manufacturing operations,” by managing “production operations from point of order release into manufacturing to point of product delivery into finished goods” and by providing “mission critical information about production activities to others across the organization and supply chain via bi-directional communication.” The international standard for developing MES systems is commonly referred as ISA-95 or S95.

The functions that a MES system usually includes are resource allocation and status, dispatching production orders, data collection/acquisition, quality management, maintenance management, performance analysis, operations/detail scheduling, document control, labor management, process management and product tracking.

Thus, the goal of MES systems developed by software suppliers is to provide manufacturing companies (the customers) with tools for measuring and controlling production activities with the aim of boosting profitability, increasing productivity, improving quality and process performance to manufacturing plants.

As used herein, a software application is a set of software components developed by software developers to perform some useful actions within a MES system, e.g. monitoring values coming from plant process or controlling a plant device.

Typically, at engineering or configuration time, system engineers flexibly customize MES applications according to the specific manufacturing plant requirements.

Instead, at runtime, MES applications are utilized by end-users who may be plant operators or line responsible personnel.

MES systems are provided with front-end/client GUI (graphical user interface) applications which may be used by end-users to plan and control manufacturing activities.

MES GUI applications play a key role in bringing together process, quality and business information from various sources into one unified real-time view of the production status of the plant. In fact, MES GUI applications display to the end-user graphical screens which enable overview several parameters or scenarios of the plant activities. Nowadays MES screens are mostly developed in form of web-pages.

In some MES systems, end users request to visualize on a MES client screen MES records through MES grids. A MES grid is a table view of several MES records. A MES record is a self-contained collection of information about a single MES object. In a MES grid, each row represents a MES record and in each column can be displayed field values of the records. MES records are typically stored on a database at the server side and the users, at the client side, may request to visualize MES records in form of grids on a MES client screen. The MES records to be visualized are the result of queries to the database at the server side.

In some manufacturing scenarios, the set of MES records that end users request to visualize via a grid at the MES client screen can include a very large number of records, e.g. several thousands or more.

The typical technique used to display a large amount of MES records on a grid is to implement a pagination of the record set on the database, i.e. by taking only a small subset of the record set at a time and by displaying it in a grid page on a MES screen. When the total records in the record set is a large number, the record set is partitioned in a given number of record subsets each of which is then visualized in a corresponding grid page. The given number of record subsets is the total number of available grid pages and it depends upon the exact total record count value in the set and upon the chosen number of records in a subset.

On the MES screen, it is also displayed a control called grid pager having navigation commands enabling the user select a grid page. The navigation commands may be page numbers, arrows to go to previous and next page, a text box to insert a page number and so on. Beside the grid pager navigation commands, it is often required that also the exact total record count value be computed and displayed so that the user has such information. However, to be able to display the total amount of available records in the record set, another action needs to be performed, i.e., a query to the database for counting the number of total records that are available in the record set resulting from the query. Once such information is available, the grid pager navigation commands can be displayed in a complete form, i.e. by including also the last page value, since only then the exact number of the last viewable grid page can be derived.

Unfortunately, when dealing with large quantities of data, the required time interval for completing the counting operation of the exact total record count value can often prove to be very long, especially when compared to the short time interval required for retrieving the small subset of records to be shown on a grid page, e.g. several seconds compared with less than half a second. The drawback is that the end user has to wait for the counting operation to be completed before being able to see and interact with the record subset displayed on the grid page.

A known technique to bypass such problem is to avoid counting all the records of the record set and to assume that there is a huge quantity of them through a rough estimate, while enabling the end user to navigate only to the next/previous grid page or a few grid pages ahead/before. When there are a great number of records, it is not likely that the end of data will be reached. The drawback of this technique is the loss of the information about the exact total number of records and consequently also about the exact total number of available grid pages.

The latter technique can work in various situations, but it is not ideal for a controlled industrial scenario. In fact, there are many situations in manufacturing scenarios where the total number of records is an important and fundamental information required by the MES user in order to monitor the correct behavior of the manufacturing plant. At the same time it is not desirable to let the user wait a long time interval without the ability to interact with the data records.

### SUMMARY OF THE INVENTION

It is therefore the object of the present invention to overcome the above mentioned drawbacks, in particular by providing a method and a system for displaying MES records on a grid in a MES client screen providing the information about the exact number of the large quantity of available records in the record set while allowing the user to interact with at least some data records.

With the above and other objects in view there is provided, in accordance with the invention, a method of displaying manufacturing execution system records in a grid or a table on an MES client screen,

wherein the MES records to be displayed are a set of records resulting from a query to a database by an MES client, and the record set is to be displayed via a plurality of grid pages each displaying a corresponding record subset, and wherein each grid page may be displayed on the MES screen by selecting given grid pager navigation commands;

the method comprising the following steps:

a) by the MES client, querying the database to retrieve a first subset of MES records from the database;

b) displaying on the MES client screen, a first grid page corresponding to a first retrieved MES record subset;

c) querying the database to count the exact total count of records of the record set to obtain an exact total record count value;

d) displaying on the screen, the exact total record count value obtained in step c); and

e) displaying on the screen grid pager navigation commands for enabling a user to select a display of another grid page for another corresponding record subset.

With the above and other objects in view there is also provided, in accordance with the invention, a system for displaying manufacturing execution system records on a grid in a MES client screen, the MES records to be displayed being a set of records resulting from a query to a database by an MES client, wherein the record set is to be displayed via a plurality of grid pages, each grid page displaying a corresponding record subset, and each grid page being selectable for display on the MES screen by way of given grid pager navigation commands. The novel system comprises:

a) a query interface enabling the MES client to query the database to retrieve a first subset of MES records from the database;

b) a display on the MES client screen, for displaying a first grid page corresponding to the retrieved first subset of MES records;

c) a query for querying the database to count the exact total count of records of the record set to obtain a total exact record count value;

d) a display for displaying on said screen an exact total record count value being a result of the query in paragraph c); and

e) a third display for displaying on said screen, grid pager navigation command links providing a user selection and causing, upon user selection, a display of another grid page for another corresponding record subset.

In accordance with an added feature of the invention, step b) may preferably comprise displaying on the screen, an image and/or a text notifying the user that the exact total count value of the MES record set is not yet available.

Furthermore, a computer program element can be provided, comprising computer program code for performing steps according to the above mentioned method when loaded in a digital processor of a computing device.

Additionally, a computer program product stored on a computer-readable medium can be provided, comprising computer readable program code for causing a computing device to perform the mentioned method.

Embodiments of the invention enable to obtain a fast loading of a first grid page viewable without losing the information on the exact total count value of the record set.

Other features which are considered as characteristic for the invention are set forth in the appended claims.

Although the invention is illustrated and described herein as embodied in displaying MES records on a grid in a MES client screen, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is a snapshot taken from an example of a first grid page where the total record count has not yet been processed, illustrating an exemplary embodiment of the present invention; and

FIG. 2 is a snapshot taken from an example of a first grid page where the total record count has already been processed according to the exemplary embodiment of the present invention.

### DETAILED DESCRIPTION OF THE INVENTION

At least some embodiments of the present invention address the above described issue in which MES records are to be displayed on a grid in a MES client screen.

The MES records to be displayed are a set of records resulting from a query to a database by the MES client. The record set is to be displayed via a number of grid pages, each grid page displaying a corresponding record subset. Each grid page can be displayed on the MES screen by selecting given grid pager navigation commands. The MES client performs a query to the database, preferably at the server side, to retrieve a first subset of MES records from the database so that a first grid page, corresponding to the first retrieved MES record subset, is displayed. As soon as this first grid page is displayed, an image and/or text may preferably be displayed on the screen notifying the user that the total count value of the MES record set is not yet available. The MES client is querying the database to count the total count of records of the record set to obtain an exact total record count value. Advantageously, while such counting query is being performed, the user is able to interact with the MES records of the first record subset. As soon as the counting query is completed, the total record count value which has been computed is displayed on the screen and also the grid pager navigation commands are displayed with the exact total number of grid pages.

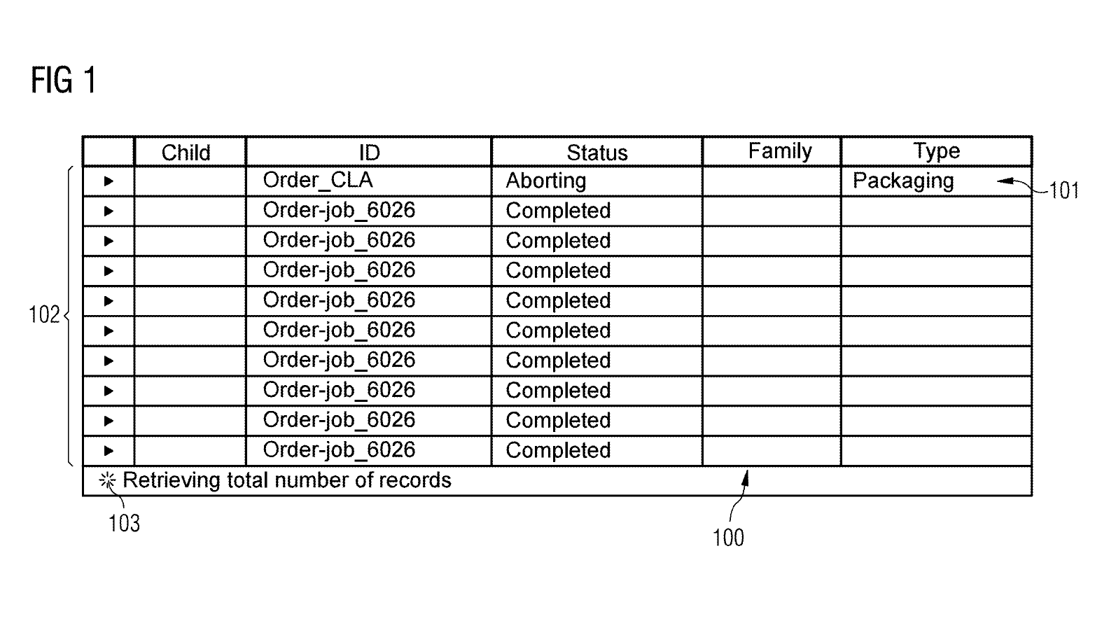

FIG. 1 shows a snapshot taken from an example of a first grid page 100 where the total record count has not been processed yet. The grid page 100 displays a first record subset 100 of MES production orders with their “ID” value and their “Status” value, e.g. “Completing” or “Aborting” and their “Type” value, e.g. “Packaging.” The record subset comprises in this example a number of 10 MES records 101. The image 103 includes a showing, in the form of an animated icon, to indicate that the total count value has not yet been computed. This may also include a display of an explanatory notification text “Retrieving total number of records.” In this snapshot screen, the grid pager navigation commands are not displayed yet since the total record count value is still under computation. The user is able to interact with the record shown in the page grid 100 but not yet able to switch to other page grids. The user in the meantime is advantageously able to select a record to be edited or to visualize a detail of a record or send it to production, when possible. The records of the first subset can preferably be the most relevant ones by using some convenient sorting criteria, for example the orders not yet executed or the orders belonging to a specific production line. In such a way performances of the MES applications are maintained when requesting to display a huge quantity of data records while the counting query is asynchronously performed.

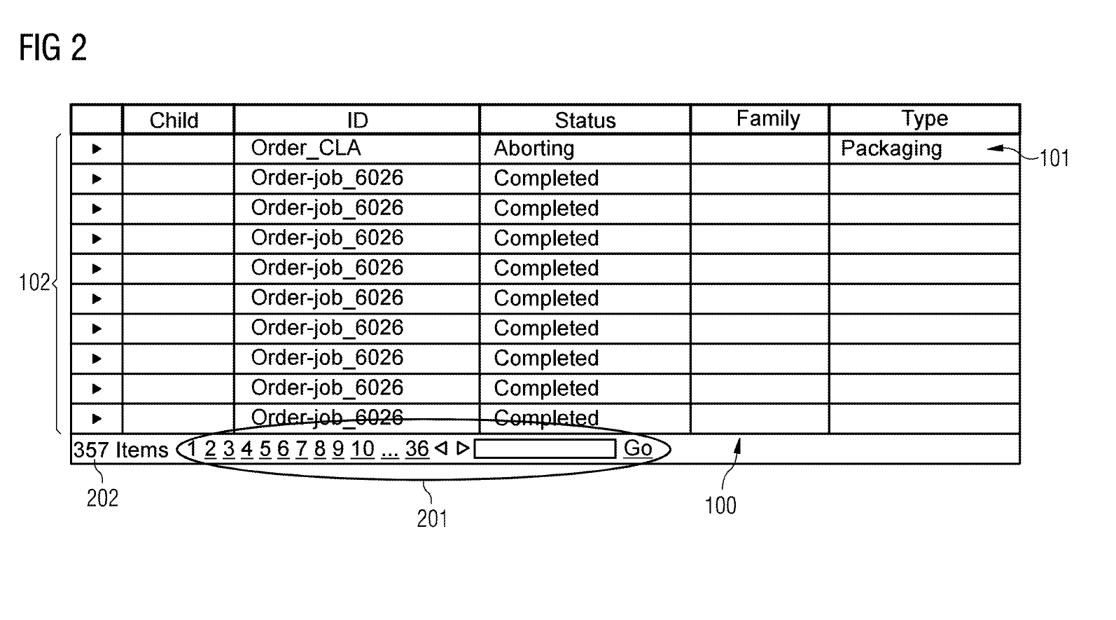

FIG. 2 is a snapshot taken from an example of the first grid page where the total record count has already been processed according to the exemplary embodiment of the present invention. The exact total record count value 202 is displayed on the screen without interference with the user's work and also the grid pager navigation commands 201 or command links 201 are displayed including the exact number of grid pages. In this simple example, the record set includes 357 records displayable in 36 grid pages each one including a maximum of 10 records. The user is able by selecting the navigation commands of the grid pager 201 to switch/navigate to other grid pages without any limitations.

1. A method of displaying manufacturing execution system records in a grid on an MES client screen,
wherein the MES records to be displayed are a set of records resulting from a query to a database by an MES client, and the record set is to be displayed via a plurality of grid pages each displaying a corresponding record subset, and wherein each grid page may be displayed on the MES screen by selecting given grid pager navigation commands;
the method comprising the following steps:
a) by the MES client, querying the database to retrieve a first subset of MES records from the database;
b) displaying on the MES client screen, a first grid page corresponding to a first retrieved MES record subset;
c) querying the database to count the exact total count of records of the record set to obtain an exact total record count value;
d) displaying on the screen, the exact total record count value obtained in step c); and
e) displaying on the screen grid pager navigation commands for enabling a user to select a display of another grid page for another corresponding record subset.

2. The method according to claim 1, wherein step b) comprises the following sub-step:
b1) displaying on said screen, an image and/or a text notifying the user that the exact total count value of the MES record set is not yet available.

3. The method according to claim 1 implemented in software.

4. A system for displaying manufacturing execution system records on a grid in a MES client screen, the MES records to be displayed being a set of records resulting from a query to a database by an MES client, wherein the record set is to be displayed via a plurality of grid pages, each grid page displaying a corresponding record subset, and each grid page being selectable for display on the MES screen by way of given grid pager navigation commands, the system comprising:
a) a query interface enabling the MES client to query the database to retrieve a first subset of MES records from the database;
b) a display on the MES client screen, for displaying a first grid page corresponding to the retrieved first subset of MES records;
c) a query for querying the database to count the exact total count of records of the record set to obtain a total exact record count value;
d) a partial display for displaying on said screen an exact total record count value being a result of the query in paragraph c); and
e) a second partial display for displaying on said screen grid pager navigation command links providing a user selection and causing, upon user selection, a display of another grid page for another corresponding record subset.
